(19) United States
(12) Patent Application Publication
(10) Pub. No.: US 2026/0035261 A1
(43) Pub. Date: Feb. 5, 2026

(54) NIOBIUM OXIDE NANOPARTICLES AND METHODS OF PRODUCING SAME

(71) Applicant: Neo Performance Materials (Singapore) Pte. Ltd., Singapore (SG)

(72) Inventors: Yong YAN, Singapore (SG); Shijia LIU, Singapore (SG); Jia Onn LIEW, Singapore (SG); Szu Hwee NG, Singapore (SG)

(73) Assignee: Neo Performance Materials (Singapore) Pte. Ltd., Singapore (SG)

(21) Appl. No.: 18/996,800

(22) PCT Filed: Jun. 1, 2024
(86) PCT No.: PCT/IB2024/055371

§ 371 Date: Jan. 17, 2025

Related U.S. Application Data
(60) Provisional application No. 63/505,571, filed on Jun. 1, 2023.

(51) Int. Cl. C01G 33/00

(52) U.S. Cl. CPC C01G 33/00; C01P 2002/72; C01P 2004/03; C01P 2004/51; C01P 2004/64; C01P 2006/10; C01P 2006/12

(57) ABSTRACT

A composition comprising nanosized niobium oxide particles having a D₅₀ of about 100 nm to about 2 μm, wherein the niobium oxide particles have a calculated particle size diameter D in nm:

$$D = \frac{6000}{S S A \times ρ}$$

where SSA is BET surface area in m²/g and p is density of 4.6 g/cm³, that is less than about 30% different than the observed particle size diameter measured by SEM. This composition has beneficial properties for catalytic and electronic uses. Processes for making these particles and uses of these particles are further included.

### CROSS-REFERENCE OF RELATED APPLICATIONS

This application is being filed on 1 Jun. 2024, as a PCT International application and claims priority to and the benefit of U.S. Provisional Patent Application No. 63/505,571 filed on 1 Jun. 2023, the disclosure of which is hereby incorporated by reference in its entirety.

### FIELD OF THE INVENTION

This application relates to compositions having nanosized Nb₂O₅ particles and processes of producing these compositions and uses for same in multilayer ceramic capacitors. The nanosized Nb₂O₅ particles have a D₅₀ of about 100 nm to about 2 μm and have a calculated particle size diameter D in nm calculated from SSA that is less than about 30% different than the observed particle size diameter as measured by SEM.

### INTRODUCTION

Niobium oxide particles have uses as catalyst supports, as well as in electrochromic devices, energy-efficient windows, oxygen sensors, photocatalysis industries, and multilayer ceramic capacitors.

In these uses, there is a need for nanosized niobium oxide particles whose size, shape, crystal structure and surface chemistry meet the requirements of such technological applications. However, the high surface energy accompanied by the ultrafine size of nanoparticles renders high possibility of particle aggregations. Thus, there is a need for high yield, efficient processes for producing dispersed nanosized niobium oxide particles. As such, increasing efforts have been devoted to the preparation of nanosized particles, whose size, shape, dispersity, crystal structure and surface chemistry meet the requirements of such technological applications.

A challenging issue is achieving an acceptable yield when synthesizing these nanosized oxides in combination with precise control over the morphology with high dispersity (size, shape, surface chemistry, particle size distribution, exposed surface facet, etc.).

Therefore, developing a simple and efficient method to prepare compositions of nanosized niobium oxides having particular morphology and particle sizes at high yields remains a need.

### SUMMARY

The nanosized Nb₂O₅ particles as disclosed herein have a D₅₀ of about 100 nm to about 2 μm and have a calculated particle size diameter D in nm calculated from SSA that is less than about 30% different than the observed particle size diameter as measured by SEM. As such, the present compositions comprise niobium oxide nanoparticles having a calculated particle size diameter D in nm:

$$D = \frac{6000}{S S A \times ρ}$$

where SSA is BET surface area in m²/g and p is 4.6 g/cm³, that is less than about 30% different than the observed particle size diameter measured by SEM. In particular embodiments, the particles have an average particle length of about 50 nm to about 1 μm. In other particular embodiments, the niobium oxide particles have a calculated particle size diameter that is less than about 25% different than the observed particle size diameter by SEM. And in further embodiments, the niobium oxide particles are crystalline. Any of these particular embodiments may be combined individually or cumulatively.

Further disclosed herein are processes of producing niobium oxide nanoparticles. These processes comprise (a) mixing a niobium salt, a polymeric additive, and a precipitant in a solvent to provide a niobium precursor solution; (b)

hydrothermally reacting the niobium precursor solution to form a precipitate; and (c) calcining the precipitate to provide niobium oxide nanoparticles having a calculated particle size dimeter D in nm:

$$D = \frac{6000}{S S A \times ρ}$$

where SSA is BET surface area in m²/g and p is 4.6 g/cm³, that is less than about 30% different than the observed particle size diameter measured by SEM.

### BRIEF DESCRIPTION OF THE DRAWINGS

FIG. 1 illustrates a flowchart of an embodiment of the process of making Nb₂O₅ nanoparticles.

FIG. 2A is a SEM of the Nb₂O₅ particles of Comparative Example 1.

FIG. 2B is a graph illustrating the PSD profile of the Nb₂O₅ particles of Comparative Example 1.

FIG. 2C is an x-ray powder diffractogram (XRPD) of the Nb₂O₅ particles of Comparative Example 1, after calcining.

FIG. 3A is a SEM of the Nb₂O₅ particles of Comparative Example 2.

FIG. 3B is a graph illustrating the PSD profile of the Nb₂O₅ particles of Comparative Example 2.

FIG. 4A is a SEM of the Nb₂O₅ particles of Example 1.

FIG. 4B is a graph illustrating the PSD profile of the Nb₂O₅ particles of Example 1.

FIG. 5A is a SEM of the Nb₂O₅ particles of Example 2.

FIG. 5B is a graph illustrating the PSD profile of the Nb₂O₅ particles of Example 2.

FIG. 5C is an x-ray powder diffractogram (XRPD) of the Nb₂O₅ particles of Example 2, after calcining.

FIG. 6A is a SEM of the Nb₂O₅ particles of Example 3.

FIG. 6B is an x-ray powder diffractogram (XRPD) of the Nb₂O₅ particles of Example 3, after calcining.

### DETAILED DESCRIPTION

Before the compositions having nanosized niobium oxide particles and processes are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present application relates to nanosized Nb₂O₅ particles. These novel nanosized particles exhibit a number of physical characteristics that distinguish them and provide improved physical characteristics and advantageous properties for end uses, such as in multilayer ceramic capacitors. These nanosized Nb₂O₅ are highly dispersed (i.e., exhibit high dispersity) meaning that the nanoparticles are discrete and not agglomerated.

Dispersity is a measure of the heterogeneity (or uniformity) of particle sizes in a mixture. It can be indicated by the polydispersity index (PDI) parameter as derived from the DLS technique or the LD technique. Specifically, from the particle size distribution (PSD) profile, the mean and standard deviation (stddev) are obtained and expressed in the form of (stddev/mean) 2 to yield the PDI value. Information on this analysis technique also can be found at https://www.materials-talks.com/blog/2017/10/23/polydispersity-what-does-it-mean-for-dls-and-chromatography/, which is herein incorporated by reference as needed.

TABLE A
Approximate values for dispersity parameters

| | | Distribution Type | | | |
|---|---|---|---|---|---|
| | | monodisperse | | polydisperse | |
| | Definition | uniform | narrow | moderate | broad |
| PDI from | =(stddev/mean)² | 0.0 | 0.0-0.1 | 0.1-0.4 | >0.4 |
| PSD | | | | | |

As illustrated in Table A, the PDI value for a perfectly uniform sample is 0.0. In some embodiments, the nanosized Nb₂O₅ particles are “monodispersed”, which means that the PDI value of the Nb₂O₅ particles is in the range of about 0.0 to about 0.1.

The Nb₂O₅ particles disclosed herein have a D₅₀ of about 100 nm to about 2 μm. The particles also have a calculated particle size diameter D in nm:

$$D = \frac{6000}{S S A \times ρ}$$

where SSA is BET surface area in m²/g and p is density in g/cm³ (and for niobium oxide particles p is 4.6 g/cm³) that is less than about 30% different than the observed particle size diameter measured by SEM. This small difference between the calculated particle size diameter versus the observed particle size diameter measured by SEM translates to a high dispersity for the Nb₂O₅ particles.

To apply the equation of determining size by SSA, one critical assumption is that the particles are discrete. A big difference in calculated versus observed suggests that the equation is not applicable/not appropriate because the particles are not discrete (i.e., are agglomerates). In some embodiments, the Nb₂O₅ particles as disclosed herein have a calculated particle size diameter D in nm that is less than about 25% different than the observed particle size diameter measured by SEM.

To derive this equation, the area of a sphere is πD², and its volume will be πD³/6. Thus, the surface area of a nano-sized material with narrow size distribution will be πD²+(πD³/6×φ. For niobium oxide, ρ is 4.6 g/cm³.

One of skill in the art understands how to determine observed particle size diameter measured by SEM. See National Institute of Standards and Technology (NIST) Special Publication 250-96, 22 pages (September 2017) Dimensional measurement of nanostructures with scanning electron microscopy, K. A. Bertness, Applied Physics Division, Physical Measurement Laboratory, which can be found at: https://doi.org/10.6028/NIST.SP.250-96. The contents of which are hereby incorporated by reference in their entirety. As explained therein, scanning electron microscopy (SEM) is widely used for the measurement of dimensions of nanostructures. Calibration of SEM magnification can be done using the ASTM E766-14 practice with NIST Reference Material (RM) 8820 and the calculation of dimensional uncertainty in the use of the calibrated SEM to measure dimensions of a fabricated nanostructure. The dimensional measurements can be performed as NIST Special Test 15510S.

In accordance with these techniques, the sample is prepared, typically by dispersing particles onto a substrate. High-resolution images of the particles are obtained from SEM, and the individual particles are measured manually using machine software. Length is determined by measuring the longest distance from one side of the particle to the other side using a straight line. Length refers to the measurement of the particle's longest side. Width is perpendicular to the length. Width is determined by measuring the distance from one side of the particle defining its length to the other side defining its length using a straight line. Width measures the particle's shorter side or the distance between its parallel sides that define its length.

In some embodiments, the particles have an average particle length of about 50 nm to about 1 μm. In some embodiments, the nanosized Nb₂O₅ particles can have a single peaked profile size. In some embodiments, the nanosized Nb₂O₅ particles have a narrow particle size profile.

Particle size analysis was done using a Microtrac S3500 particle size analyzer. A typical measurement is done by using approximately 0.1 grams of a powder sample, 10 ml of a 2% sodium hexametaphosphate solution is added to the sample. The sample+solution are then sonicated for approximately 3 minutes. A few drops of the sonicated solution are then added to the sample container of the instrument. The sample is again sonicated in the machine for another 3 minutes. Three consecutive runs are done by the machine according to the instrument manufacturer instruction manual. The three runs are averaged and the results recorded. The above determines the D₅₀ of the sample.

Laser diffraction (LD) is used for measuring particle size distribution (PSD). Dynamic light scattering (DLS) technique is another technique that can be used to measure PSD. While both LD and DLS can be used to measure PSD, the model used is different. For DLS, the velocity of particle movement is a function of the particle size. For LD, the diffracted/scattered intensity vs. angle (diffraction pattern) is a function of the particle size. Although they are based on different models, the dispersity theory should be the same since it is only a mathematic calculation based on the PSD.

As described, the niobium oxide particles disclosed herein are nanosized niobium oxide particles.

The niobium oxide particles also can be crystalline. In some embodiments, the crystalline niobium oxide particles are orthorhombic.

The nanosized niobium oxide particles also have favorable surface area. In some embodiments the particles have a BET surface area of about 5 m²/g to about 100 m²/g. The BET surface area of the compositions was determined by using a Micromeritics Tristar II system and nitrogen at about 77 Kelvin. In compliance with commonly accepted procedures, the determination of surface area as used herein, the application of the BET equation was limited to the pressure range where the term na (1-P/Po) of the equation continuously increases with P/Po. The out gassing of the sample was done under nitrogen at about 350 degrees Celsius for about 2 hours.

The nanosized Nb₂O₅ particles also can exhibit a favorable loss on ignition (LOI). In some embodiments, the nanosized Nb₂O₅ particles as disclosed herein have a loss on ignition (LOI) at the calcination temperature of less than 6%. In certain embodiments, the LOI is 0.1% to about 6%. As described herein, LOI was measured by determining the sample mass before and after calcination of the products at 1000° C. for 1h.

These additional characteristics, including crystalline embodiments, BET, LOI, particle size profiles, and particle lengths may be combined with any of the embodiments described supra. These additional embodiments may be individually or cumulatively combined the general description of the nanosized Nb₂O₅ particles as described supra.

Without being bound by any theory, it is believed that the nanosized niobium oxide particles as described herein and having the particular D₅₀ and particle size diameter provide many beneficial technical effects, particularly for use in multilayer ceramic capacitors. The unique shape in combination with the size provide for better mixing and no significant agglomeration. This leads to improved efficiencies in end uses, such as in multilayer ceramic capacitors. The particularly recited shape and size may provide for improved electrical performances of dielectrics and reliability. Electric properties and related reliability may be attributed to the particularly recited shape and size. The particularly recited shape and size may improve the solubility and distribution of the niobium oxide particles described herein.

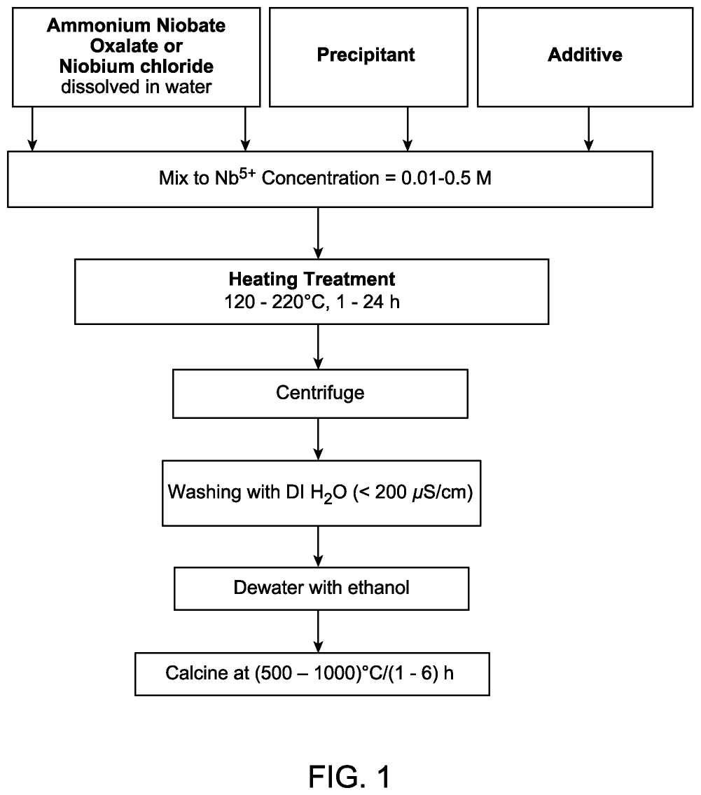

The nanosized Nb₂O₅ particles disclosed herein are made by a particular process that provides the Nb₂O₅ particles disclosed herein having a D₅₀ of about 100 nm to 2 μm and having a calculated particle size diameter D in nm:

$$D = \frac{6000}{S S A \times ρ}$$

where SSA is BET surface area in m²/g and ρ is density in g/cm³ (for niobium oxide particles ρ is 4.6 g/cm³) that is less than about 30% different than the observed particle size diameter measured by SEM. FIG. 1 is a flow chart for an embodiment of a process of producing the nanosized Nb₂O₅ particles as described herein.

This process includes steps of (a) mixing a niobium salt, a polymeric additive, and a precipitant in a solvent to provide a niobium precursor solution; (b) hydrothermally reacting the niobium precursor solution to form a precipitate; and (c) calcining the precipitate to provide niobium oxide nanoparticles having a calculated particle size dimeter D in nm:

$$D = \frac{6000}{S S A \times ρ}$$

where SSA is BET surface area in m²/g and ρ is density of 4.6 g/cm³, that is less than about 30% different than the observed particle size diameter measured by SEM. The disclosed process provides the nanosized Nb₂O₅ particles as disclosed and described above, including all of the above described properties individually or cumulatively.

In step (a) the niobium salt, polymeric additive, and precipitant are mixed in a solvent to provide a niobium precursor solution. The order of addition is not important, and any order of addition may be utilized. The solvent is water and in particular, deionized water. The niobium salt of step (a) may be ammonium niobate, niobium chloride, or mixtures thereof. In certain embodiments the niobium salt is ammonium niobate oxalate with an oxide content of 30.6%. In certain embodiments, the niobium salt is dissolved in water first and then the polymeric additive and precipitant are then added to and dissolved in this solution. In other embodiments, the niobium salt, polymeric additive, and precipitant can be dissolved individually in water and then these solutions can be mixed.

The precipitant may be selected from the group consisting of oxalic acid, tartaric acid, urea, ammonium phosphate, ammonium citrate, and mixtures thereof. In certain embodiments, the precipitant is oxalic acid, diammonium citrate, tartaric acid, or mixtures thereof.

The polymeric additive may be selected from the group consisting of polyvinyl alcohol, polyvinylpolypyrrolidone, polyethylene glycol, polyethyleneimine, and mixtures thereof. In certain embodiments the polymeric additive is polyethylene glycol, polyvinylpolypyrrolidone, or mixtures thereof.

In certain embodiments, the precipitant is oxalic acid, tartaric acid, ammonium citrate, or mixtures thereof and the polymeric additive is polyvinylpolypyrrolidone, polyethylene glycol or mixtures thereof.

In embodiments, the niobium salt, polymeric additive, and precipitant may be mixed to an Nb⁵⁺ concentration of about 0.01 to about 0.5 M.

The solution of step (a) is mixed. The solution may be mixed thoroughly by stirring for about 30 minutes to about 6 hours. In other embodiments, the solution may be mixed by sonication, and then by stirring. In additional embodiments, the sonication step may be omitted.

The mixed solution of step (a) is then hydrothermally reacted to form a precipitate. The solution may be hydrothermally reacted at a temperature of about 120° C. to about 220° C. for about 1 hour to about 24 hours.

Before calcining the precipitants in step (c), the precipitants from step (b) may be collected. The precipitants may be collected by filtration or centrifugation. This precipitants may be collected and dried in an oven. The precipitants may be dried at about 50° C. to about 100° C. for about 3 hours to about 12 hours before calcining.

In certain embodiments, the collected precipitates may be washed with deionized water to a conductivity of less than about 200 μS/cm. In embodiments, the collected precipitates may be dewatered. In embodiment including dewatering, the collected precipitates may be dewatered with ethanol. In embodiments including washing with water and/or dewatering, the process may further include drying the precipitants at about 50° C. to about 100° C. for about 3 hours to about 12 hours before calcining.

Finally, the precipitants are calcined to provide the niobium oxide nanoparticles as disclosed herein. The precipitates may be calcined at a temperature of about 500° C. to about 1000° C. for about 1 hour to about 6 hours. The calcining should be sufficient to remove the polymeric additive. In particular embodiments, the precipitants are calcined at about 700° C. for 1 hour.

The process as disclosed herein provides the nanosized niobium oxide particles described herein having the recited properties.

FIG. 1 is a flow chart for an embodiment of a process of producing nanosized niobium oxide particles, as illustrated in the Examples that follow.

In the following, Examples are given to illustrate the inventive method for the preparation of nanosized Nb₂O₅ particles and characterization thereof in more detail, although the scope of the invention is never limited thereby in any way.

In the following Examples, a JEOL JSM6010LV was used to take SEM (Scanning Electron Microscope) images to determine the particle size range and morphology. A Hitachi SU5000 FE-SEM was used to take high-resolution SEM images to determine the average particle size and morphology. A Microtrac S3500 was used to determine the D₅₀ of the sample. Malvern Panalytical Empyrean X-ray diffractometers were used to determine the crystalline structures of the final products. A Micromeritics Tristar was used to determine the specific surface area (SSA) of the final products. Finally, a muffle furnace was used to determine the LOI by calcining the sample at 1000° C. for 1 hour.

The comparative examples disclosed herein depict Nb₂O₅ particles having a calculated particle size diameter D that is measurably greater than about 30% different than the observed particle size diameter measured by SEM. This greater difference in the calculated particle size diameter D versus the observed particle size diameter measured by SEM results because the nanoparticles are less discrete (i.e., are more agglomerated).

### Comparative Example 1: Making Nb₂O₅ Nanoparticles without a Polymeric Additive

The following was done:
1) 2.5 g Ammonium Niobate Oxalate (Oxide content=30.6%) and 4.2 g oxalic acid dihydrate were weighed and dissolved in 100 ml DI water.
2) 0.038 g ammonium phosphate was added into the above solution along with 50 mL DI water.
3) The mixture was stirred such that clear colourless solution was obtained.
4) The mixture was then transferred into a 200 mL hydrothermal reactor.
5) Hydrothermally treated the mixture at 220° C. for 2 h.
6) The precipitates were collected by centrifugation and washed with deionized water to achieve a conductivity of less than 200 μS/cm.
7) The solid was dewatered with ethanol to obtain a wetcake.
8) The wetcake was dried at 60° C.
9) The dried product was calcined at 700° C. for 1h.

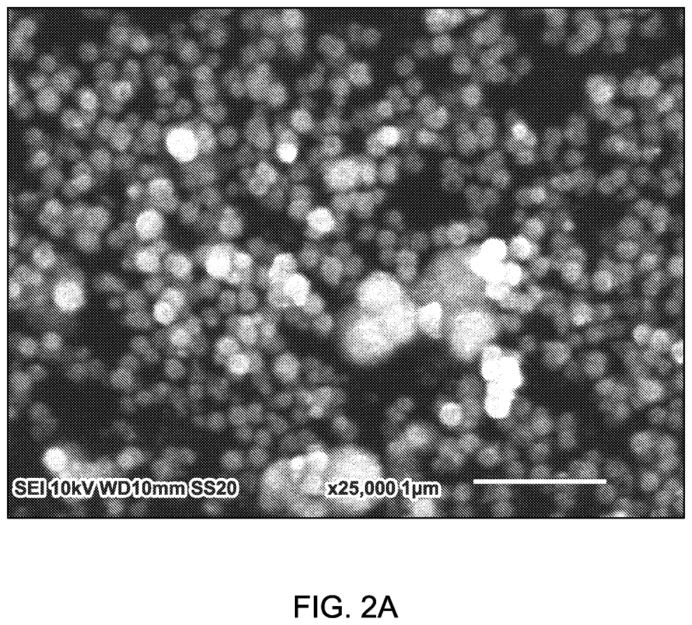

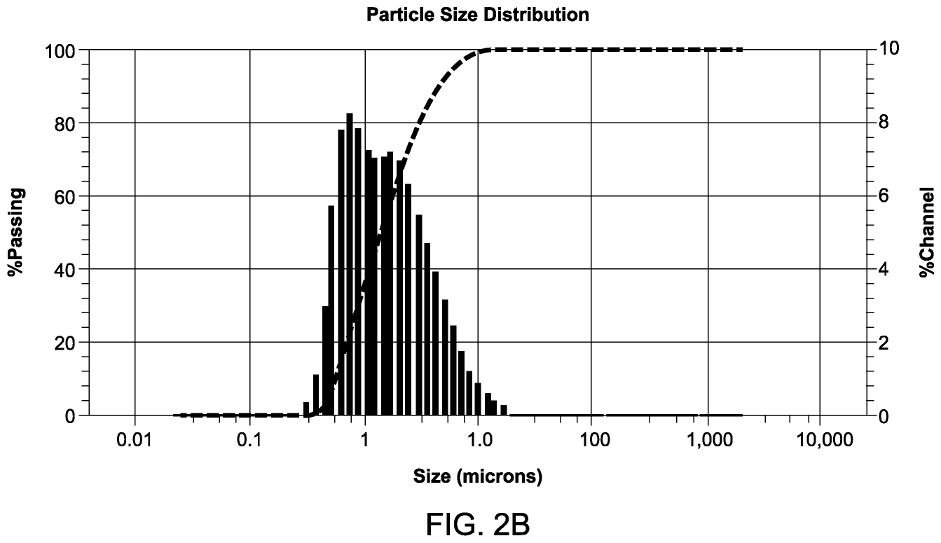

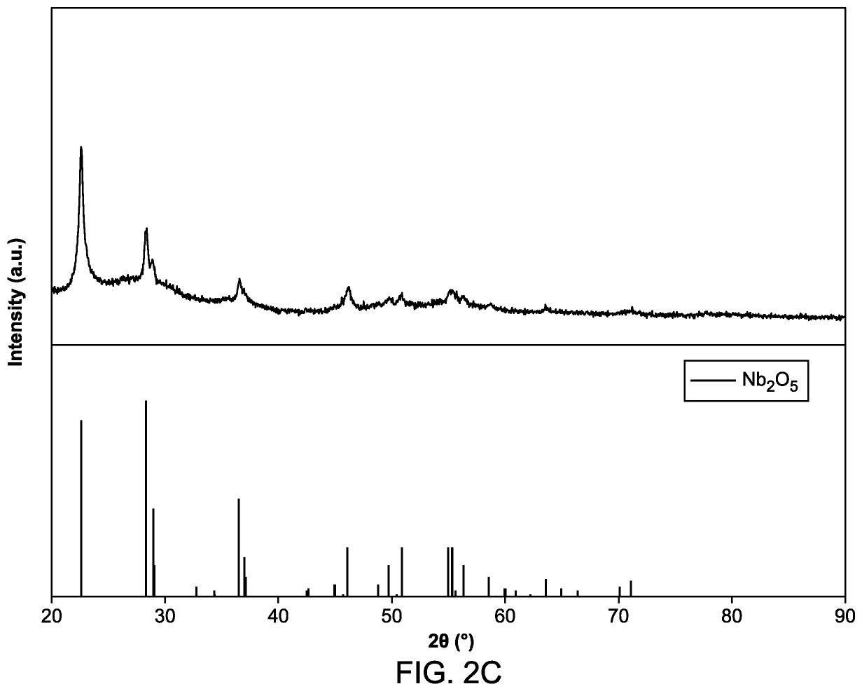

The Nb₂O₅ particles appeared spherical. The Nb₂O₅ particles were analyzed by SEM (FIG. 2A). As examined by SEM, the Nb₂O₅ particles had an average particle size of about 147.0 nm (50 particle measurement by SEM) and a SizeBET of about 30.3 nm. FIG. 2B is a graph illustrating the PSD profile of the Nb₂O₅ particles.

TABLE 1
Characteristics of Comparative Example 1

| | | |
|---|---|---|
| SSA | 43.0 | m²/g |
| D₅₀ | 1.441 | μm |

| | |
|---|---|
| LOI | 5.58% |
| Length | 300 nm-1 μm |

The Nb₂O₅ particles also were analyzed by XRPD (FIG. 2C) and showed characteristics of orthorhombic-Nb₂O₅.

### Comparative Example 2: Making Nb₂O₅ Nanoparticles

The following was done:
1) 2.5g of Ammonium Niobate Oxalate (Oxide content=30.6%) was weighed and dissolved in 150 ml DI water.
2) 4.2 g of oxalic acid, 3.8 g polyvinylpolypyrrolidone (MW˜1,300,000) and 0.048 g tartaric acid were added into the above solution.
3) The mixture was stirred for 60 minutes.
4) The mixture was then transferred into a 200 mL hydrothermal reactor.
5) The mixture was hydrothermally treated at 220° C. for 2 hours.
6) The precipitates were collected by centrifugation and washed with DI water to achieve a conductivity of less than 200 μS/cm.
7) The solid was dewatered with ethanol to obtain a wetcake.
8) The wetcake was dried at 80° C. for 12 hours.
9) The dried product was calcined at 700° C. for 1 hour.

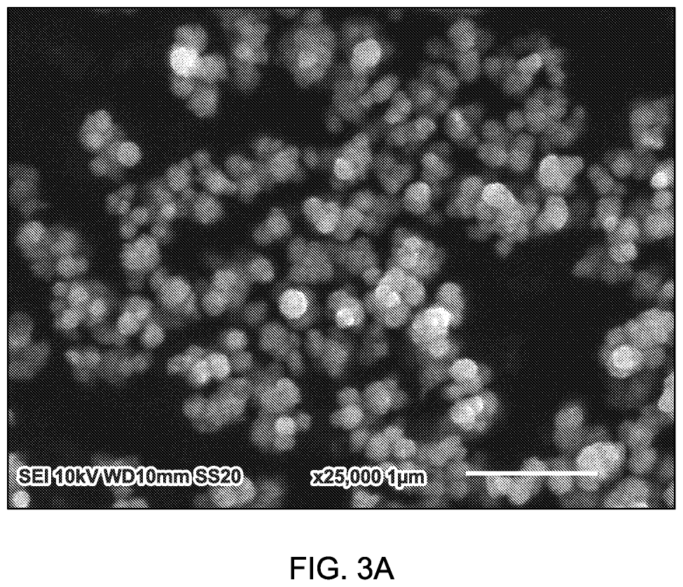

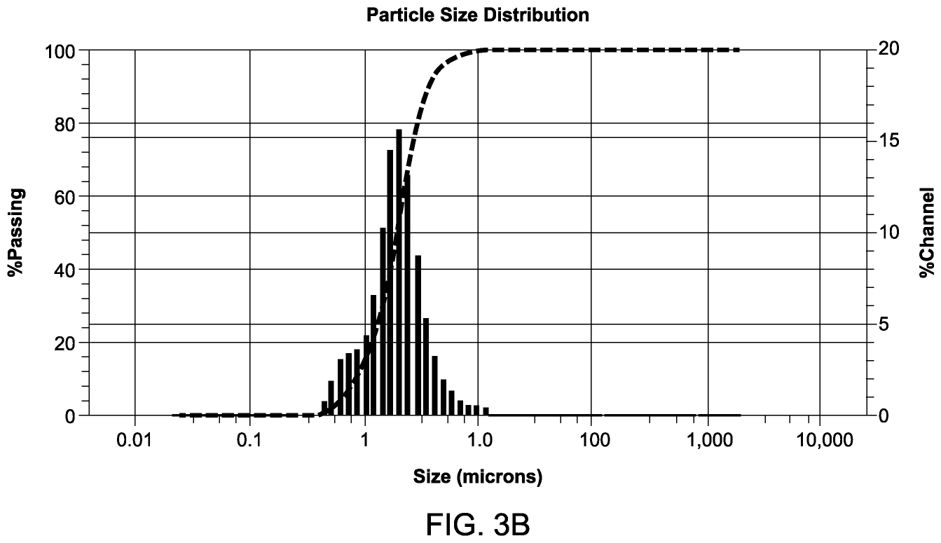

The Nb₂O₅ particles were nanosized. The Nb₂O₅ particles were analyzed by SEM (FIG. 3A). As examined by SEM, the Nb₂O₅ particles had an average particle size of about 171.8 nm (50 particle measurement by SEM) and a SizeBET of about 247.9 nm. FIG. 3B is a graph illustrating the PSD profile of the Nb₂O₅ particles.

TABLE 2
Characteristics of Comparative Example 2

| | | |
|---|---|---|
| SSA | 5.26 | m²/g |
| D50 | 1.976 | μm |

### Example 1: Making Nb₂O₅ Nanoparticles

The following was done:
1) 2.5 g of Ammonium Niobate Oxalate (Oxide content=30.6%) was weighed and dissolved in 150 ml DI water.
2) 4.2 g of oxalic acid and 0.048 g tartaric acid were added into the above solution.
3) The mixture was stirred for sixty minutes.
4) The mixture was then transferred into a 200 mL hydrothermal reactor.
5) The mixture was hydrothermally treated at 220° C. for 1.5 hours.
6) The precipitates were collected by centrifugation and washed with DI water to achieve a conductivity of less than 200 μS/cm.
7) The solid was dewatered with ethanol to obtain a wetcake.
8) The wetcake was dried at 80° C. for twelve hours.
9) The dried product was calcined at 700° C. for one hour.

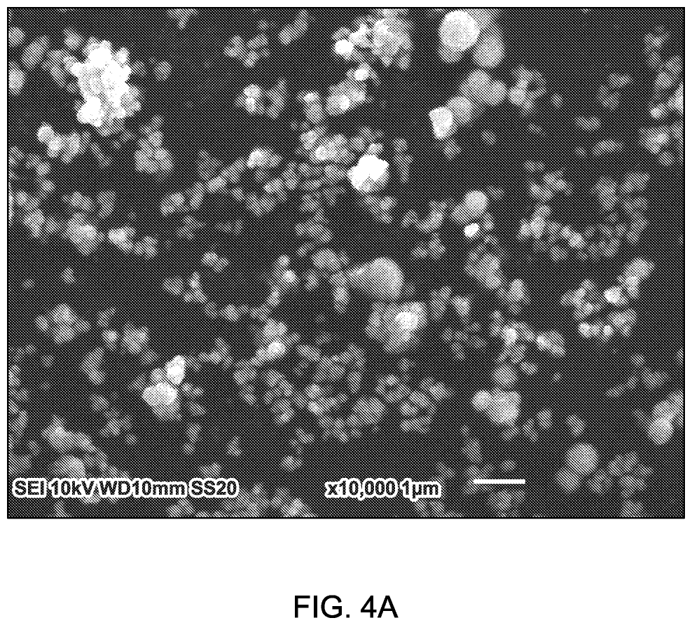

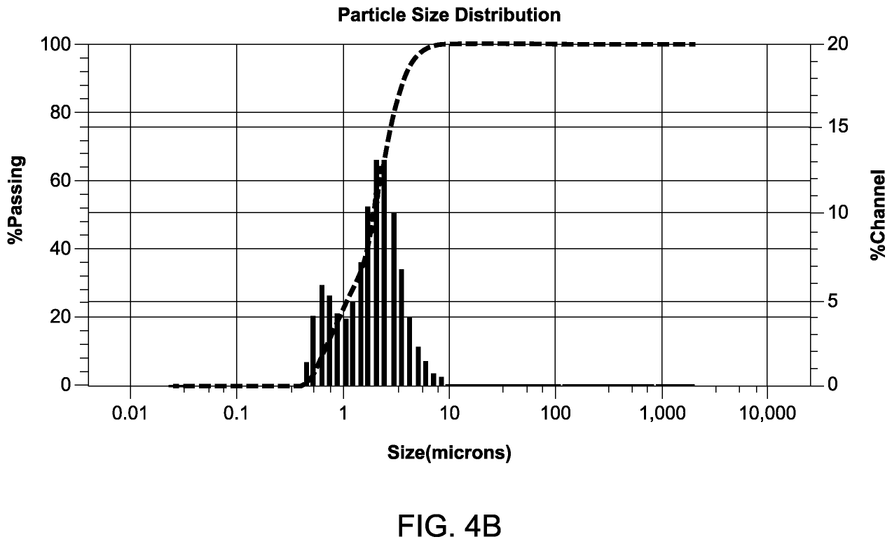

The Nb₂O₅ particles were nanosized. The Nb₂O₅ particles were analyzed by SEM (FIG. 4A). As examined by SEM, the Nb₂O₅ particles had an average particle size of about 184.2 nm (50 particle measurement by SEM) and a SizeBET of about 143.7 nm. FIG. 4B is a graph illustrating the PSD profile of the Nb₂O₅ particles.

TABLE 3
Characteristics of Example 1

| | | |
|---|---|---|
| SSA | 9.08 | m²/g |
| D50 | 1.949 | μm |

### Example 2: Making Nb₂O₅ Nanoparticles

The following was done:
1) 2.5 g Ammonium Niobate Oxalate (Oxide content=30.6%) and 4.2 g oxalix acide dihydrate were weighed and dissolved in 150 ml DI water.
2) 0.3 g PVP (MW b˜1300K) was added into the above solution.
3) 0.3 g diammonium citrate was added into the solution along with 50 mL DI water.
4) The mixture was stirred until all the components were dissolved.
5) The mixture was then transferred into a 200 mL hydrothermal reactor.
6) Hydrothermally treated the mixture at 220° C. for 2 h.
7) The precipitates were collected by centrifugation and washed with deionized water to achieve a conductivity of less than 200 μS/cm.
8) The solid was dewatered with ethanol to obtain a wetcake.
9) The wetcake was dried at 60° C.
10) The dried product was calcined at 700° C. for 1h.

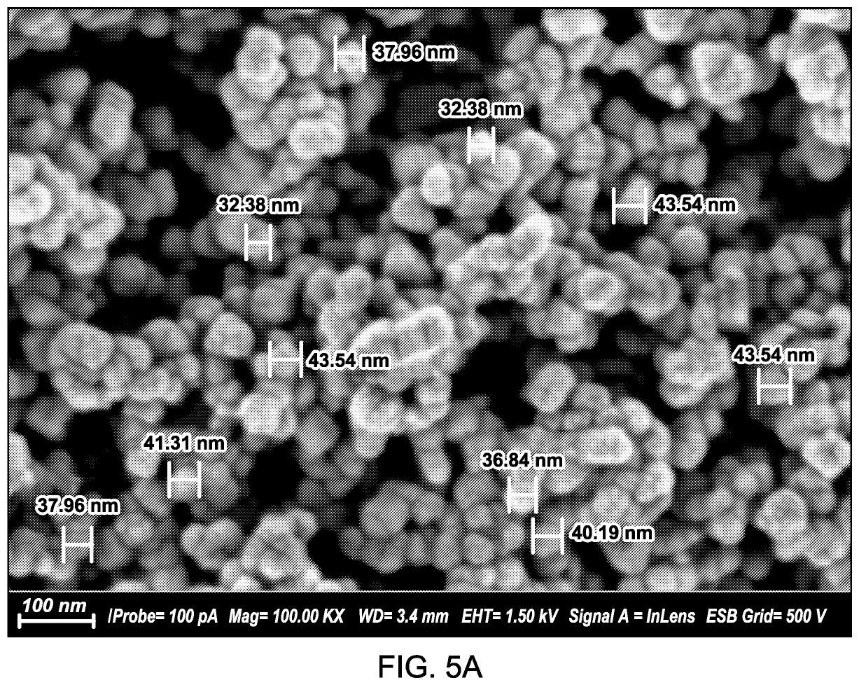

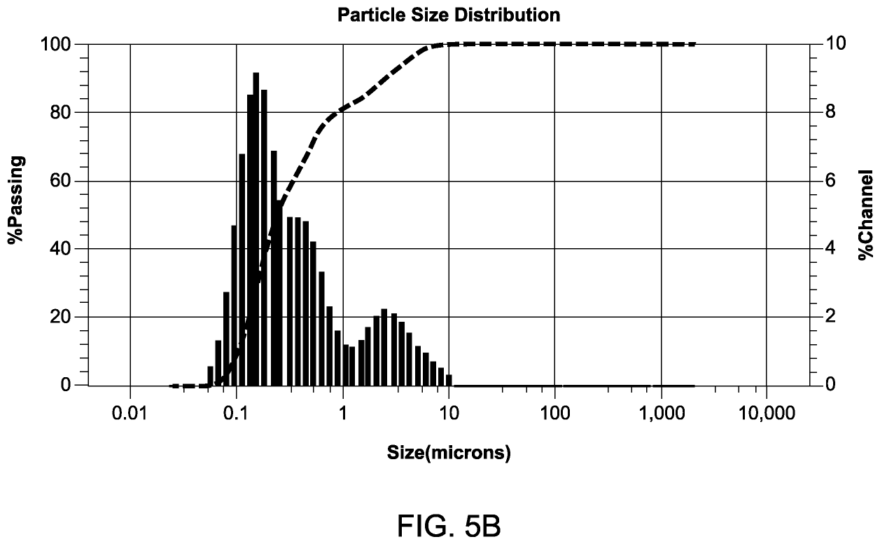

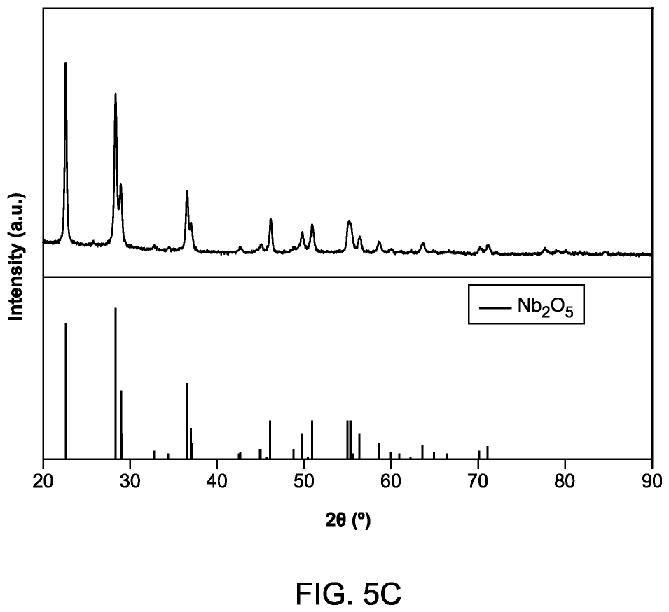

The Nb₂O₅ particles were nanosized. The Nb₂O₅ particles were analyzed by SEM (FIG. 5A). As examined by SEM, the Nb₂O₅ particles had an average particle size of about 38.7 nm (50 particle measurement by SEM) and a SizeBET of about 45.9 nm. FIG. 5B is a graph illustrating the PSD profile of the Nb₂O₅ particles.

TABLE 4
Characteristics of Example 2

| LOI | 5.05% | |
|---|---|---|
| SSA | 28.4 | m²/g |
| D50 | 248 | nm |

The Nb₂O₅ particles also were analyzed by XRPD (FIG. 5C) and showed characteristics of orthorhombic-Nb₂O₅.

### Example 3: Making Nb₂O₅ Nanoparticles

The following was done:
1) 66.7 g Ammonium Niobate Oxalate (Oxide content=30.6%) was weighed and dissolved in 800 ml DI water, which was then topped up to a total volume of 1L with DI water.
2) 2.04 g oxalic acid and 1.9 g polyvinylpolypyrrolidone (MW˜10,0000) were added into 150 ml of the above Nb precursor solution.
3) The mixture was stirred at room temperature for 60 min.
4) The mixture was then transferred into a 200 mL hydrothermal reactor.
5) Hydrothermally treated the mixture at 180° C. for 36 h.
6) The precipitates were collected by centrifugation and washed with deionized water to achieve a conductivity of less than 200 μS/cm.
7) The solid was dewatered with ethanol to obtain a wetcake.
8) The wetcake was dried at 80° C.
9) The dried product was calcined at 700° C. for 1h.

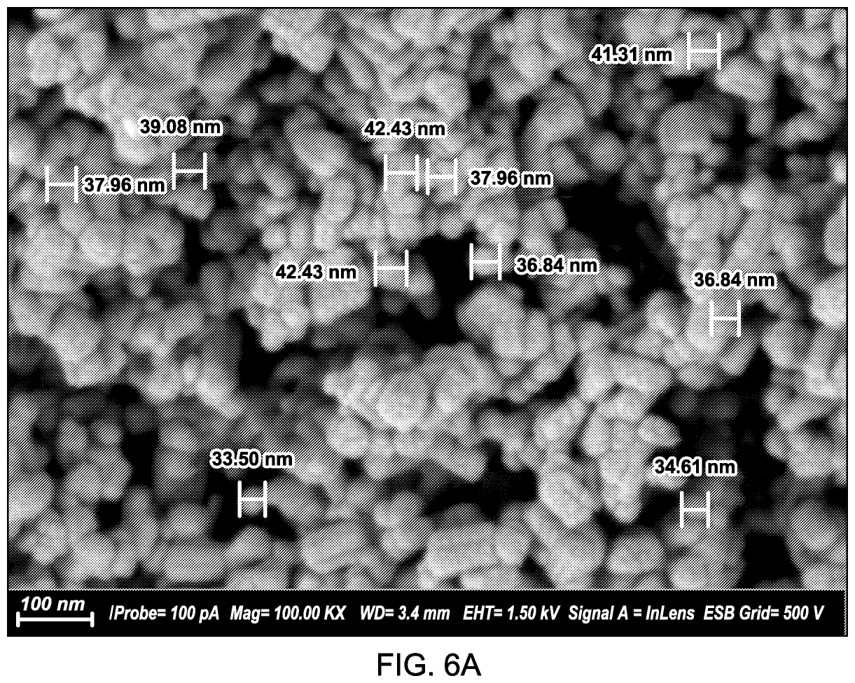

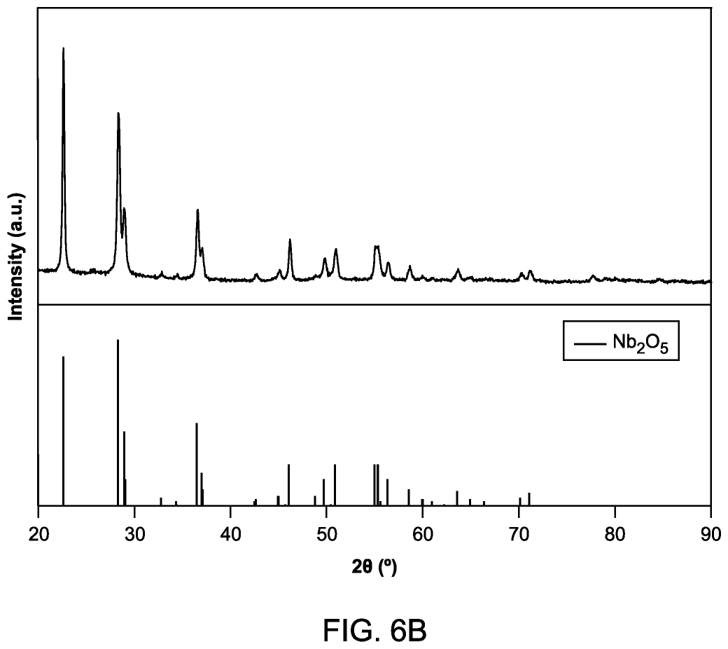

The Nb₂O₅ particles were nanosized. The Nb₂O₅ particles were analyzed by SEM (FIG. 6A). As examined by SEM, the Nb₂O₅ particles had an average particle size of about 38.2 nm (50 particle measurement by SEM) and a SizeBET of about 47.3 nm. The Nb₂O₅ particles also were analyzed by XRPD (FIG. 6B) and showed characteristics of orthorhombic-Nb₂O₅.

TABLE 5
Characteristics of Example 3

| SSA | 27.6 m²/g |
|---|---|
| LOI | 1.82% |

### Summary of Calculated Particle Size Diameter vs Observed for Examples vs Comparative Examples

The following table summarizes the calculated particle size diameter vs the observed particle size diameter measured by SEM for the Nb₂O₅ nanoparticles as made herein. The Nb₂O₅ particles of the present disclosure have a calculated particle size diameter D in nm:

$$D = \frac{6000}{S S A \times ρ}$$

where SSA is BET surface area in m²/g and ρ is 4.6 g/cm³, that is less than about 30% different

than the observed particle size diameter measured by SEM.

The results confirm that the comparative examples are significantly greater.

TABLE 6
Comparison of Calculated Particle Size vs Observed

| | Size by SEM | Size by SSA | Difference |
|---|---|---|---|
| Example Number | (nm) | (nm) | (%) |
| 1 | ~184.2 | 143.7 | 22.0 |
| 2 | ~38.7 | 45.9 | 18.6 |
| 3 | ~38.2 | 47.3 | 23.8 |
| CP 1 | ~147.0 | 30.3 | 79.4 |
| CP 2 | ~171.8 | 247.9 | 44.3 |

CP: Comparative

As shown, the Nb₂O₅ nanoparticles as disclosed herein have a calculated particle size diameter D in nm:

$$D = \frac{6000}{S S A \times ρ}$$

where SSA is BET surface area in m²/g and ρ is density of 4.6 g/cm³, that is less than about 30% different than the observed particle size diameter measured by SEM. In contrast, the comparative Nb₂O₅ particles (comparative examples) exhibit a calculated particle size diameter D that is measurably greater than the observed particle size diameter indicating that these particles have less desirable dispersity with noticeable aggregation. A big difference indicates that the particles are not discrete.

The Nb₂O₅ nanoparticles as disclosed herein having the particularly recited particle size diameter D and size provide many beneficial technical effects, particularly for use in multilayer ceramic capacitors. The unique shape in combination with the size provide for better mixing and no significant agglomeration. This leads to improved efficiencies in end uses, such as multilayer ceramic capacitors.

As devices such as multilayer capacitors are desired to be smaller and lighter, the components must assist in achieving this end result. The particularly recited shape and size may provide for improved electric performances of dielectrics and reliability. Electric properties and related reliability may be attributed to solubility and distribution of rare earth oxides. The particularly recited shape and size may improve the solubility and distribution of the rare earth oxide particles as described herein.

The spherical morphologies as defined herein and the particularly recited size may be beneficial for their use as powders, dispersion in liquid mediums, and for better mixing with and occupation of sites BaTiO₃ ceramics. The particles as disclosed herein may provide for improved electric performance and high reliability. The electric properties and related reliability of these capacitors can be attributed to solubility, distribution of the rare earth oxides, and their occupation site in BaTiO₃. The rare earth oxide particles as disclosed with the particularly recited spherical morphology and size may improve these properties.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A composition comprising niobium oxide nanoparticles, having a D₅₀ of about 100 nm to about 2 μm, wherein the niobium oxide particles have a calculated particle size diameter D in nm:
$$D = \frac{6000}{S S A \times ρ}$$
where SSA is BET surface area in m²/g and ρ is 4.6 g/cm³, that is less than about 30% different than the observed particle size diameter measured by SEM.

2. The composition of claim 1, wherein the particles have an average particle length of about 50 nm to about 1 μm.

3. The composition of claim 1, wherein the niobium oxide particles have a calculated particle size diameter that is less than about 25% different than the observed particle size diameter by SEM.

4. The composition of any one of claims 1-3, wherein the particles have a BET surface area of about 5 m²/g to about 100 m²/g.

5. The composition of any one of claims 1-4, wherein the particles are crystalline.

6. The composition of claim 5, wherein the particles are crystallized orthorhombic.

7. The composition of any one of claims 1-6, wherein the composition has a Loss on Ignition (LOI) of about 0.1% to about 6%.

8. The composition of any one of claims 1-7, wherein the particles are monodispersed.

9. A process of producing niobium oxide nanoparticles, the process comprising:
(a) mixing a niobium salt, a polymeric additive, and a precipitant in a solvent to provide a niobium precursor solution;
(b) hydrothermally reacting the niobium precursor solution to form a precipitate; and
(c) calcining the precipitate to provide niobium oxide nanoparticles having a calculated particle size dimeter D in nm:
$$D = \frac{6000}{S S A \times ρ}$$
where SSA is BET surface area in m²/g and ρ is 4.6 g/cm³, that is less than about 30% different than the observed particle size diameter measured by SEM.

10. The process of claim 9, wherein the precipitant is selected from the group consisting of oxalic acid, tartaric acid, urea, ammonium phosphate, ammonium citrate, and mixtures thereof.

11. The process of claim 9 or 10, wherein the polymeric additive is selected from the group consisting of polyvinyl alcohol, polyvinylpolypyrrolidone, polyethylene glycol, polyethyleneimine, and mixtures thereof.

12. The process of any one of claims 9-11, wherein in step b) the niobium precursor solution is hydrothermally reacted at a temperature of about 120° C. to about 220° C. for about 1 hour to about 24 hours.

13. The process of any one of claims 9-12, wherein in step c) the precipitate is calcined at a temperature of about 500° C. to about 1000° C. for about 1 hour to about 6 hours.

14. The process of any one of claims 9-13, further comprising collecting the precipitants of step (b) by centrifugation and washing the precipitants with deionized water to a conductivity of less than about 200 μS/cm before calcining.

15. The process of claim 14, further comprising dewatering the precipitates of step (b) before calcining.

16. The process of any one of claims 9-15, further comprising collecting the precipitants and drying at about 50° C. to about 100° C. for about 2 hours to about 12 hours before calcining.

17. The process of claim 9, wherein the mixing of step (a) is by stirring or sonication.

18. The process of claim 9, wherein the Nb⁵⁺ concentration of the solution of step (a) is about 0.01 to about 0.5 M.

19. The process of any one of claims 9-11, wherein niobium salt is ammonium niobate oxalate with an oxide content of about 30.6%.

20. The process of claim 19, wherein the precipitant is oxalic acid, tartaric acid, ammonium citrate, or mixtures thereof and the polymeric additive is polyvinylpolypyrrolidone, polyethylene glycol or mixtures thereof.

21. Niobium oxide nanoparticles made by the process of any one of claims 9-20.
